(19) United States
(12) Patent Application Publication
(10) Pub. No.: US 2025/0165379 A1
(43) Pub. Date: May 22, 2025

(54) ACTION SEQUENCE GENERATION FOR INTELLIGENT SOFTWARE TESTING

(71) Applicant: Microsoft Technology Licensing, LLC, Redmond, WA (US)

(72) Inventors: William Tigard BAKER, Redmond, WA (US); Swamy V.P.L.N. NALLAMALLI, Bothell, WA (US); Dallas Allen WARREN, Redmond, WA (US); Aaron Edward DIETRICH, Kirkland, WA (US); Piyush GUPTA, Kirkland, WA (US); Robert M. FRIES, Kirkland, WA (US)

(73) Assignee: Microsoft Technology Licensing, LLC, Redmond, WA (US)

(21) Appl. No.: 18/517,223

(22) Filed: Nov. 22, 2023

(51) Int. Cl. G06F 11/36; G06F 8/51

(52) U.S. Cl. CPC G06F 11/3684; G06F 8/51

(57) ABSTRACT

A system and method for providing automated action sequence generation. An action sequence generated utilizes a natural language processing system to automatically generate a sequence of actions that a software testing tool can exercise on a software under test based on identified natural language instructions that describe the actions. For instance, the natural language processing system identifies cues describing action instructions and converts the instructions into the software testing tool's programming language-specific language for executing actions in a sequence (i.e., an action sequence). The software testing tool can then replay action sequences and perform specific actions requested by or otherwise relevant to the customer.

### BACKGROUND

Automated software testing for complex environments, such as operating systems or the applications running thereon, simulates diverse ways in which users interact with the software being tested. Simulated usage during testing allows for detection of bugs before they turn into usability or security issues after deployment. In some examples, automated testing includes autonomously exploring and exercising software products by observing a current state of the software product, selecting an action to perform based on the observed state, and performing the action. In other examples, automated testing includes authoring tests that include specific actions that are automatically exercised against the software product.

It is with respect to these and other considerations that examples have been made. In addition, although relatively specific problems have been discussed, it should be understood that the examples should not be limited to solving the specific problems identified in the background.

### SUMMARY

The technology described herein provides automated action sequence generation for automated software testing. A natural language processing system is used to identify and convert natural language instructions to perform actions on software under test into instructions in a software testing tool's programming language-specific language for executing the natural language actions in a sequence (i.e., an action sequence). The software testing tool can then replay generated action sequences on the software under test and perform specific actions requested by or otherwise relevant to the customer. Accordingly, action sequences can be automatically generated for the software testing tool without requiring technical expertise to author a custom action sequence and relevant actions can be exercised in a time and resource efficient method.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The present disclosure is illustrated by way of example by the accompanying figures, in which like references indicate similar elements. Elements in the figures are illustrated for simplicity and clarity and have not necessarily been drawn to scale.

FIG. 1 is a block diagram of an example software testing environment in which automated action sequence generation may be implemented according to an aspect;

FIG. 2A is a data flow diagram of an example data flow for providing automated action sequence generation according to an aspect;

FIG. 2B is a data flow diagram of an example data flow for providing automated action sequence generation according to an aspect;

FIG. 3 is a flow diagram depicting an example method of providing automated action sequence generation according to an aspect;

FIG. 4 is a flow diagram depicting an example method of providing automated action sequence generation according to an aspect; and

FIG. 5 is a block diagram illustrating example physical components of a computing device with which aspects of the disclosure may be practiced.

### DETAILED DESCRIPTION

Examples described in this disclosure relate to systems and methods for providing automated action sequence generation. As mentioned above, a current automated testing method includes random exploration, where a testing tool autonomously explores and exercises actions on a software product by observing a current state of the software, selecting an action to perform based on the observed state, and performing the action. For instance, an automated testing tool may randomly explore paths it finds based on elements observed through one or more Application Programming Interfaces (APIs) (e.g., interactive user interface (UI) elements observed on a screen of the computing device and Representational State Transfer (REST)-ful services observed through a REST API). While random exploration provides broad coverage for testing software products, in some examples, finding and exercising particular scenarios that may be relevant to a customer (e.g., testing a specific feature or validating a bug fix) can be time-consuming and computing resource-intensive. For instance, multiple test iterations may need to be performed to find and perform specific actions. In other examples, a software product may be tested using an automated testing method that includes performing specific manually authored actions against the software product. Some example current methods of customizing behavior of a test may include authoring a stand-alone test or manually crafting action replay sequences. While these methods may reduce the amount of time to exercise a particular scenario in comparison to random exploration methods, manually authoring automated software product tests can entail significant resource expenses, such as time, effort, money, and/or specialized skills.

Thus, a natural language processing system is provided that automatically generates a sequence of actions that the software testing tool can exercise on a software product based on received natural language content. For instance, the natural language processing system may identify and convert natural language instructions to perform actions on the software product into instructions in the software testing tool's programming language-specific for executing the natural language actions in a sequence (i.e., an action sequence). The software testing tool can then replay generated action sequences on the software under test and perform specific actions requested by or otherwise relevant to the customer. Accordingly, action sequences can be automatically generated for the software testing tool without requiring technical expertise to author a custom action sequence and relevant actions can be exercised in a time and resource efficient method.

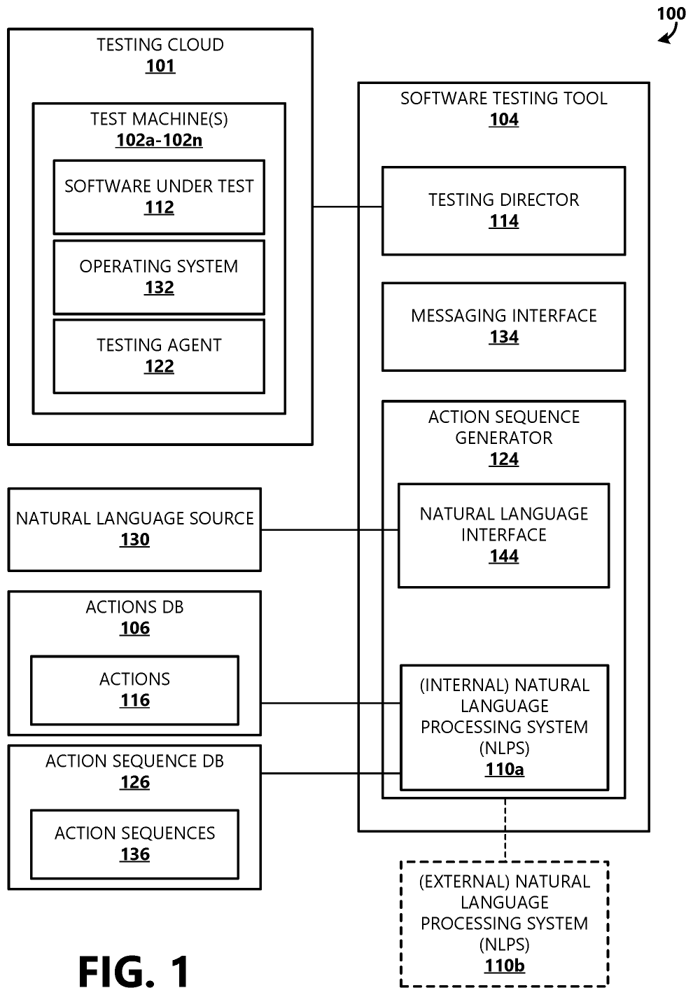

FIG. 1 is a block diagram of a software testing environment 100 in which automated action sequence generation for software product testing may be implemented in accordance with examples described herein. Among other components not shown, the software testing environment 100 includes a testing cloud 101 including one or a plurality of test machines 102a-102n (collectively, test machine 102) and a software testing tool 104 connected, in some examples, by a network.

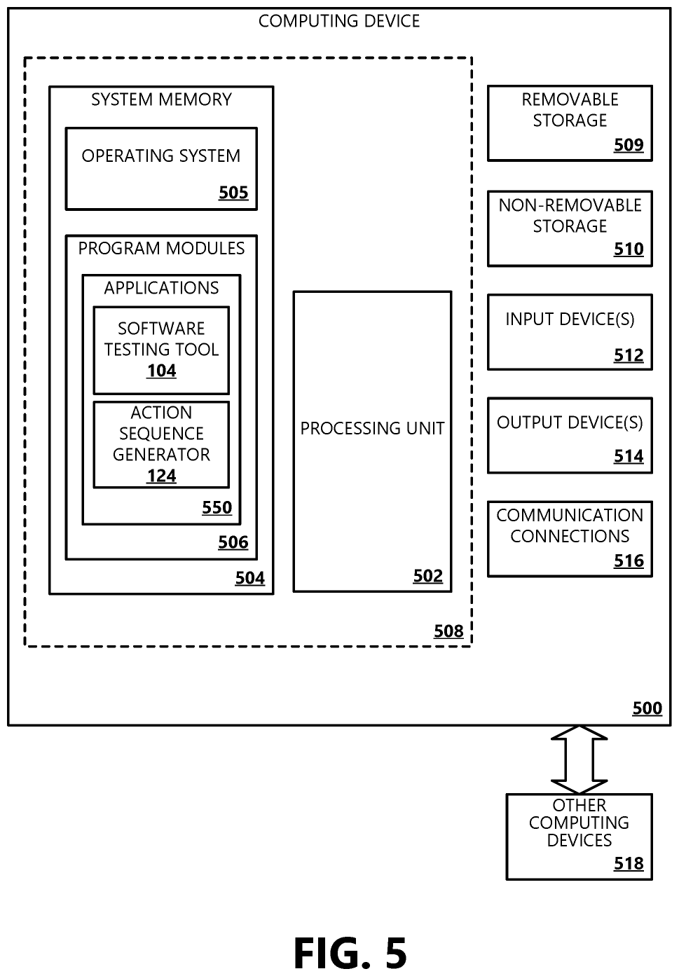

The example software testing environment 100, as depicted, is a combination of interdependent components that interact to form an integrated whole. Some components are illustrative of software applications, systems, or modules that operate on a computing device or across a plurality of computer devices. Any suitable computer device(s) may be used, including web servers, application servers, network appliances, dedicated computer hardware devices, virtual server devices, personal computers, a system-on-a-chip (SOC), or any combination of these and/or other computing devices known in the art. In one example, components of systems disclosed herein are implemented on a single processing device. The processing device may provide an operating environment for software components to execute and utilize resources or facilities of such a system. An example of a processing device comprising such an operating environment is depicted in FIG. 5. In another example, the components of systems disclosed herein are distributed across multiple processing devices. For instance, input may be entered on a user device or client device and information may be processed on or accessed from other devices in the network, such as one or more remote cloud devices or web server devices. The network may include one or more local area networks (LANs) and/or wide area networks (WANs). In example implementations, a network includes the Internet, an intranet, and/or a cellular network, amongst any of a variety of possible public and/or private networks.

The software testing tool 104 includes an action sequence generator 124 that utilizes natural language processing to automatically generate a sequence of actions 116 for the software testing tool 104 to exercise on software under test 112. In some examples, the action sequence generator 124 includes an internal natural language processing system (NLPS) 110a (e.g., internal to the action sequence generator 124 and/or the software testing tool 104) or is in communication with an external NLPS 110b (e.g., external to the action sequence generator 124) (collectively, NLPS 110) to identify instructions included in received natural language content that correspond to actions 116 that may be included in an action sequence 136. In further examples, the action sequence generator 124 uses the NLPS 110 to convert the identified instructions into programming language-specific instructions for the software testing tool 104 to execute. Programming language-specific instructions are instructions in a programming language (e.g., a domain-specific language, such as JavaScript Object Notation (JSON)) used by the software testing tool 104 to perform actions on software under test 112.

The software testing tool 104 further includes a testing director 114 that assigns tests to the test machines 102. In examples, assigning a test to the test machine 102 includes communicating an action sequence 136 to a testing agent 122. In some examples, the testing agent 122 operates on the test machine 102. In other examples, the testing agent 122 is located on a different machine than the software under test 112. The testing agent 122 attempts to take the actions 116 included in the action sequence 136 and, in some examples, determine a resulting state for software under test 112. In other examples, the resulting state is determined by another component (e.g., a service health monitoring system). In examples, the action sequence 136 communicated to the testing agent 122 represents an ordered/sequential list of instructions in the software testing tool's programming language-specific language for performing the actions 116 in the action sequence 136.

Each test machine 102 may be a virtual machine or a physical machine that includes an operating system 132, the software under test 112, and the testing agent 122. In some examples, the testing agent 122 opens the software under test 112 and starts to interact with the software under test 112 via an API supported by the software under test. The testing agent 122 observes a current state within the environment of the software under test 112, performs an action 116 in the action sequence 136, and observes a next state of the software under test 112.

In some examples, the testing agent 122 leverages an accessibility layer of the operating system 132 of the test machine 102 to observe a current state of the software under test 112 through an interface (e.g., a user interface (UI) for desktop applications). For instance, a state is a description of software and machine conditions at a point in time. A software state includes interface objects (e.g., visible and not visible interface objects), where interacting with an interface object may produce a second state with different interface objects. The testing agent 122 observes the UI elements that are on screen of the test machine 102, which UI elements can be interacted with, etc. In other examples, the software testing tool 104 directly interacts with the service under test 112 via REST APIs.

Actions 116 include possible interactive actions with the software under test interface. For instance, actions 116 include an action (e.g., select, hover, enter text) a user of the software under test 112 may perform with a UI element (e.g., button, menu or menu item, text box, checkbox, dropdown list, hyperlink, or other type of link). In one aspect, the actions 116 are determined through interrogation of an accessibility layer (e.g., the MICROSOFT User Interface (UI) Automation System). For instance, the accessibility layer or function framework are used by applications, such as screen readers, for low vision users. The number of available actions 116 for each state may be dynamic. Some software products have a very large action space. For example, the software under test 112 may have 100,000 or more available actions 116. In examples, actions 116 corresponding to the software under test 112 are stored in an actions database 106. In some examples, the stored actions 116 include actions identified during testing of the software under test 112.

The actions database 106 stores actions 116 included in action telemetry data. In some examples, action telemetry data is received from the testing agent 122. In other examples, action telemetry data is received from the software testing tool 104. Action telemetry data may include descriptions of all (or a subset of) actions 116 the software testing tool 104 performed on the test machine(s) 102 in relation to one or more versions of the software under test 112 and an associated resulting state. For instance, as actions 116 are taken during testing, both the action taken and the resulting state are communicated to and stored in the actions database 106. In examples, action telemetry data includes instructions corresponding to performing the action 116. In further examples, the instructions include programming language-specific instructions in a programming language-specific language used by the software testing tool 104. As an example, programming language-specific instructions for clicking a Start button associated with a file manager process may be represented by {Action: Click, UIObject: StartMenuButton, Process: filemanager.exe}. In further examples, the action telemetry data includes natural language metadata, where natural language metadata is data providing information about an action 116 taken against the software under test 112. For instance, the phrase “click the Start button” is an example of natural language metadata that provides information about an instruction to perform an action 116 in natural human language, rather than or in addition to structured or technical formatted language. In examples, actions 116 are stored as key value pairs in a multi-model database service, such as a key-value store, with operative information for the software testing tool 104 to perform the action 116.

Operative information to perform an action 116 includes details of the action and preconditions/target of the action (if any). In examples, the operative information includes key-value pairs that specify details and parameters that describe how the action is to be performed. As an example, for the action 116 of clicking a “Bold” button in a word processing application (software under test 112), the detail of the action may include {ActionType: Click} and a precondition may be that the bold button must be on screen. Details to identify the bold button in the software under test 112 may be required, including fields such as: (Process name: WORDPROCESSOR), (AutomationId: TASKBAR_Bold), (ClassName: Button), and (ParentIdentifier: GUID representation of the taskbar that contains the bold button). As another example, for an action 116 including dragging a shortcut onto a desktop of the test machine 102, the preconditions may include details to uniquely identify the shortcut. The action details may include additional information about the action 116 (e.g., drag direction, drag speed, drag duration). In a further example, an action 116 may include performing a series of REST calls, where the details include: the REST API(s) being called and parameter(s) being provided to the REST call(s). Preconditions, which are not always required, may include dynamic objects previously created (e.g., via POST calls to the service).

An action sequence 136 includes steps (e.g., actions 116) taken to perform a task, such as changing font color to red. In order to change the font color to red, the steps may include opening a document, selecting text, opening the font menu, and selecting red from available font colors. In some examples, different paths for performing the same task (e.g., for changing font color) exist. The task may relate to particular (e.g., new or modified) features of the software under test 112, where an action sequence 136 is exercised on the software under test 112 to test/validate the particular feature, validate a bug fix, etc. In some examples, the result of performing an action sequence 136 corresponds to the occurrence of a significant event in the software under test 112. For instance, the result can correspond to a negative event in the software under test 112, such as an exception, a crash or a degradation in performance. Alternatively, the result can correspond to a positive event in the software under test 112, such as a new customer scenario being validated.

According to an aspect, the software testing tool 104 leverages natural language processing methods of the NLPS 110 to automatically generate an action sequence 136 based on natural language describing actions 116 the software testing tool 104 can exercise on the software under test 112. In some examples, the software testing tool 104 includes one or more natural language interfaces 144 that receive natural language content from a natural language source 130. The natural language content may include natural language instructions that describe interacting with the software under test 112. In some examples, the natural language instructions are identified and interpreted as a sequence of actions 116 (i.e., an action sequence 136) to perform on the software under test 112. The NLPS 110 receives the natural language content and converts natural language action instructions identified in the natural language content into instructions in the testing tool's programming language-specific language for performing the action sequence 136. In an example, the natural language action instructions are converted into programming language-specific key value pairs with operative information for the software testing tool 104 to be able to perform the actions 116 of the action sequence 136 on the software under test 112. The software testing tool 104 can replay the action sequence 136, which, in some examples, includes performing specific steps (e.g., performing a task) requested by the customer, rather than (or in addition to) randomly exploring paths found in the software under test 112. Thus, the software testing tool 104 can exercise scenarios (e.g., action sequences 136) that are relevant to the customer. For instance, relevant scenarios/action sequences 136 are exercised more quickly (and with fewer processing steps) than through an exploration and random discovery process. In some examples, a relevant action sequence 136 includes specific actions 116 that are requested by a customer (or another user), identified as important to the customer, time sensitive to the customer, included in documentation corresponding to the software under test 112, included in documentation corresponding to a code update submission for the software under test 112, etc. In an example, the results of performing a relevant action sequence 136 correspond to validating a new customer scenario for the software under test 112. In further examples, using the NLPS 110 to automatically generate action sequences 136 circumvents requiring technical expertise to author a custom action sequence 136 for the software testing tool 104.

In some implementations, the software testing tool 104 includes a messaging interface 134 that operates as a natural language source 130 and receives natural language content from a user through messages. Examples of the messaging interface 134 include a chat-based interface or other type of conversational interface. For instance, via the messaging interface 134, the user may provide natural language content describing various actions 116 for the software testing tool 104 to exercise against the software under test 112. As an example, the user may type, speak, or otherwise provide the natural language content, “Launch Application A (i.e., software under test 112), create a document, click the Bold button, click the Italics button, and then type the text ‘Hello World’”. Accordingly, the software testing tool 104 utilizes the NLPS 110 to identify and convert natural language instructions in the received natural language content into corresponding programming language-specific instructions for the software testing tool 104 to execute.

In some examples, a natural language source 130 is embodied as a code update submission (e.g., a pull or merge request). The software testing tool 104 may include a natural language interface 144 that receives natural language content included in a code update submission for the software under test 112. For example, the code update submission may correspond to submitting a code update to a repository, where the submission may take the form of a “pull request” requesting that the update be pulled (e.g., merged) into the repository. The code update submission may be associated with adding coverage for new product features, validating bug fixes, etc. In examples, the software under test 112 may include source code associated with the code update submission for inclusion in a body of source code. The code update submission may include a portion that directly or indirectly includes source code, where at least a part of that source code is updated relative to a previous version of the source code. The code update submission may include additional portions, (e.g., a routing portion, an authorization portion, a history portion, a timestamp). In some examples, the code update submission includes a comments portions including comments from an author of the source code and/or a reviewer of the source code. Accordingly, the software testing tool 104 utilizes the NLPS 110 to identify and convert natural language instructions to perform a sequence of actions 116 included in the one or more natural language portions of the code update submission into corresponding programming language-specific instructions for the software testing tool 104 to execute.

In other examples, the natural language source 130 is a manual test (e.g., a file or other record of manual instructions) for validating the software under test 112. For example, UI-based software under test 112 may include a suite of manual tests that may be performed by human testers to validate features of the software under test 112 are working as expected. For instance, human testers are provided with the list of steps to perform for each manual test case. In examples, the NLPS 110 is leveraged to convert the lists of steps in the manual tests into programming language-specific language of the software testing tool 104. The manual tests (e.g., lists of steps) may be recorded in a medium other than a file, such as being stored in a database, a custom “manual test” repository, or other datastore. In other examples, the natural language source 130 includes a project management (PM) specification for the software under test 112, a design document (e.g., authored by developers and including technical details and/or specifications of the software under test 112), or another software document. For instance, the natural language interface 144 may receive or query a datastore for manual tests, PM specifications, design documents, and/or other types of natural language sources 130 for obtaining natural language action instructions that can be converted into programming language-specific instructions for the software testing tool 104.

In some implementations, the action sequence generator 124 includes or is in communication with an external NLPS 110b.) The external NLPS 110b is accessible to the action sequence generator 124 via one or more APIs exposed by the action sequence generator 124 or exposed to the action sequence generator 124 by the external NLPS 110b. The external NLPS 110b is one or more of a generative AI model, a language model (LM), a multimodal model, or other type of AI model. For instance, a generative AI model generates new data that is similar to the data it was trained on, an LM understands or generates human language, and a multimodal model can understand or generate multiple types of data, such as text, images, and sound. The external NLPS 110b is operative to receive natural language content as an input, identify action instructions in the natural language content, and provide an output including the identified action instructions. Action instructions are identified by the external NLPS 110b using various LM functionalities, such as text processing, context understanding, Named Entity Recognition (NER), pattern recognition, semantic understanding.

In some examples, the LM is a large language model (LLM), where the LM is an artificial intelligence model that has been trained on vast amounts of textual data to understand and generate human-like language. Example LMs include GPT-3, GPT-4, Large Language Model Meta AI (LLaMA) 2, BigScience, Large Open-science Open-access Multilingual Language Model (BLOOM), Bidirectional Encoder Representations from Transformers (BERT), Word2Vec, Global and Vectors (GloVe), Embeddings from Language Models (ELMo), and XLNet. In some examples, the external NLPS 110b is implemented using a neural network, such as a deep neural network, that utilizes a transformer architecture to process received input. Such an architecture employs a decoder or an encoder-decoder structure and self-attenuation mechanisms to process the received input. Initial processing of the prompt includes tokenizing the prompt into tokens that are then mapped to a unique integer or mathematical representation. The integers or mathematical representations are combined into vectors that have a fixed size. These vectors are known as embeddings.

The initial layer of the transformer model receives the token embeddings. One or more of the subsequent layers in the model uses a self-attention mechanism that allows the transformer model to weigh the importance of each token in relation to every other token in the token embeddings. In other words, the self-attention mechanism may compute a score for each token pair, which signifies how much attention should be given to other tokens when encoding a particular token. These scores are then used to create a weighted combination of the token embeddings.

In some examples, one or more layers of the transformer model consists of two primary sub-layers: a self-attention sub-layer comprising the self-attention mechanism and a feed-forward sub-layer comprising a feed-forward neural network. The self-attention mechanism mentioned above is applied to the token embeddings to generate attention output vectors. The feed-forward neural network then applies a simple neural network to each of the attention output vectors. Accordingly, the output of one layer of the transformer model becomes the input to the next of the transformer model, which means that each layer incrementally builds upon the understanding and processing of the previous layers. The output of the final layer may be processed and passed through a linear layer and/or a softmax activation function. The linear layer and/or the softmax activation function outputs a probability distribution over all possible tokens in the transformer model's vocabulary. The tokens with the highest probability are selected as the output tokens for the corresponding token embeddings.

In some examples, the action sequence generator 124 provides a prompt as input to the external NLPS 110b that includes at least a portion of natural language content received from a natural language source 130 and a request to identify actions 116 (e.g., instructions to perform actions) included in the natural language content. In response to the prompt, the external NLPS 110b generates a response that includes identified action instructions. As an example, when provided with natural language content (e.g., received from a message, a pull request, a PM specification, design document, comments), the external NLPS 110b provides a response, such as natural language instructions to perform actions 116 interpreted from the natural language content (e.g., launch Application A, create a document, click the Bold button, click the Italics button, and type the text ‘Hello World’). In some examples, the prompt further includes a request to convert identified action instructions into the testing tool's programming language-specific language. For instance, the external NLPS 110b may be trained on vast amounts of textual data to further understand and generate programming language-specific instructions in a language used by the software testing tool 104 to test the software under test 112 or may be provided with examples of the programming language-specific instructions.

In example implementations, the internal NLPS 110a is a machine learning model that has been trained to provide programming language-specific instructions for the software testing tool 104 to perform an action sequence 136 against the software under test 112 based on an input of natural language instructions about a sequence of actions 116. The internal NLPS 110a is created by first obtaining training data, which may be structured or unstructured data. Training data is an initial set of data used to the internal NLPS 110a to learn and understand how to provide programming language-specific instructions for performing an action sequence 136. The training data may include examples of correct input-output pairs of natural language metadata that correspond to programming language-specific instructions for performing various actions 116, which are used to adjust parameters of the internal NLPS 110a and improve its performance. As an example, natural language metadata included in training data may include the actions 116 “Locate and select the ‘Comment’ button, then add and post your comment”, where the training data further includes the programming language-specific instructions for enabling the software testing tool 104 to perform the actions 116 of identifying the ‘Comment’ button, selecting the ‘Comment’ button, typing text into a comment provided in response to selecting the ‘Comment’ button, identifying a ‘Post Comment’ button, and selecting the ‘Post Comment’ button. The training data may also include various data labels identifying UI elements, UI element locations within a UI (e.g., pixel coordinates), UI element interactions (e.g., select, hover, drag UI element), UI element interaction duration, or an expected state/result.

Once the training data is obtained, a training module receives the training data and an untrained model. The untrained model can have preset weights and biases, which can be adjusted during training. It should be appreciated that the untrained model can be selected from many different model forms depending on the task to be performed. For example, for a model that is to be trained to perform image classification, the untrained model may be a model form of a convolutional neural network (CNN). The training can be supervised learning, semi-supervised learning, unsupervised learning, reinforcement learning, and/or the like, including combinations and/or multiples thereof. The training may be performed multiple times (referred to as “epochs”) until a model reaches a predefined or desired performance threshold. Some example indicators to assess whether the action sequence generator 124 has reached a predefined or desired performance threshold include low training and validation losses monitored during training, the convergence of learning curves that represent the change in training and validation performance over epochs, and other evaluation metrics indicating the accuracy of the action sequence generator 124. For example, when training a model to predict a next action in an action sequence and it consistently predicts the correct action with high probability, training losses would be low. Validation losses may be calculated on a separate set of data not used in training. Once trained, the action sequence generator 124 is configured to provide, as an output, programming language-specific instructions for performing actions 116 in an action sequence 136 based on received natural language content (e.g., from a natural language source 130) by applying the trained internal NLPS 110a to new data (e.g., real-world, non-training data).

Action sequences 136 generated by the action sequence generator 124 may be stored in an action sequence database 126. In examples, the action sequence 136 includes key value pairs with operative information for the software testing tool 104 to determine the actions 116 in the action sequence 136 to be performed. For instance, operative information for performing a drag action, such as dragging a UI element, included in an action sequence 136 includes: locating a UI element on a UI based on an identifier for the UI element, simulating a mouse press on the located UI element, recording initial coordinates (e.g., a starting position) of the mouse at the onset of the mouse press; simulating a mouse move that causes the UI element to move based on a specified direction, speed, and duration of the drag action; and simulating the release of the mouse press. Examples of the key-value pairs for the drag action include the following:

```
Locate the UI element:
  Key: ″elementLocator″
  Value: ″xpath=//div[@id=′dragElement′]″
Simulate mouse press:
  Key: ″action″
  Value: ″mousePress″
Record initial coordinates:
  Key: ″initialX″
  Value: ″100″ (X-coordinate of the mouse pointer)
  Key: ″initialY″
  Value: ″200″ (Y-coordinate of the mouse pointer)
Simulate mouse move:
  Key: ″action″
  Value: ″mouseMove″
  Key: ″moveDirection″
  Value: ″right″ (Direction of mouse movement)
  Key: ”dragSpeed”
  Value: ”dragSpeed: 500”
  Key: ”dragDuration”
  Value: ”2 seconds”
Simulate mouse release:
  Key: ″action″
  Value: ″mouseRelease″.
```

In some examples, the action sequence database 126 further stores an expected state/result associated with an action sequence 136 being performed. In some examples, the programming language-specific instructions are further executed by the software testing tool 104, where a state/result of executing the programming language-specific instructions is compared against an expected state/result.

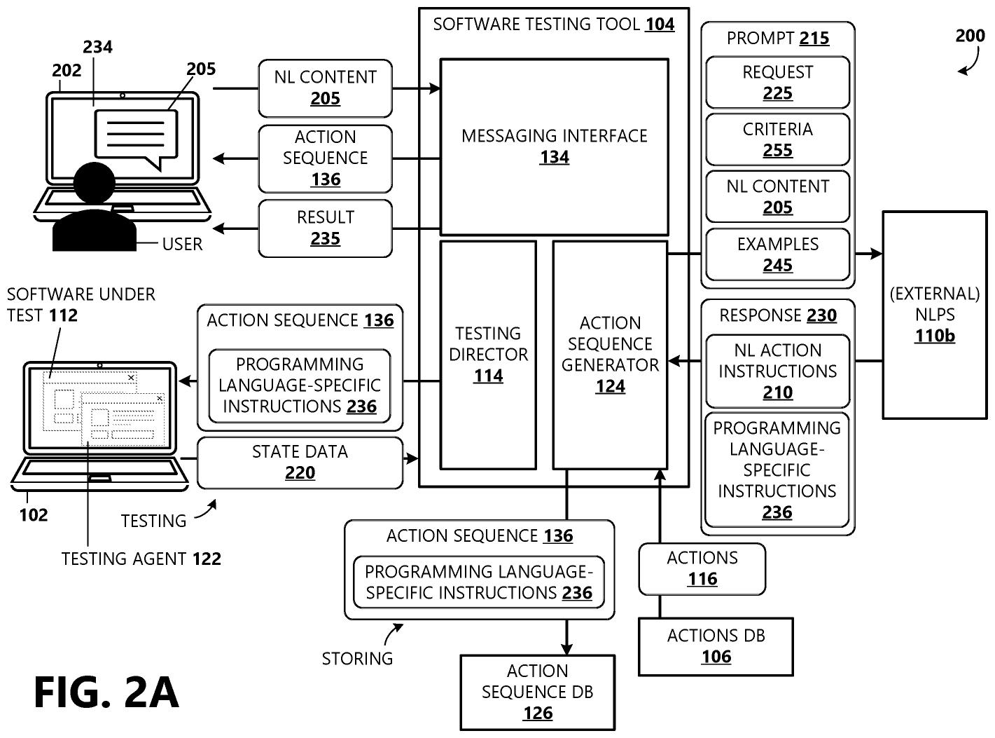

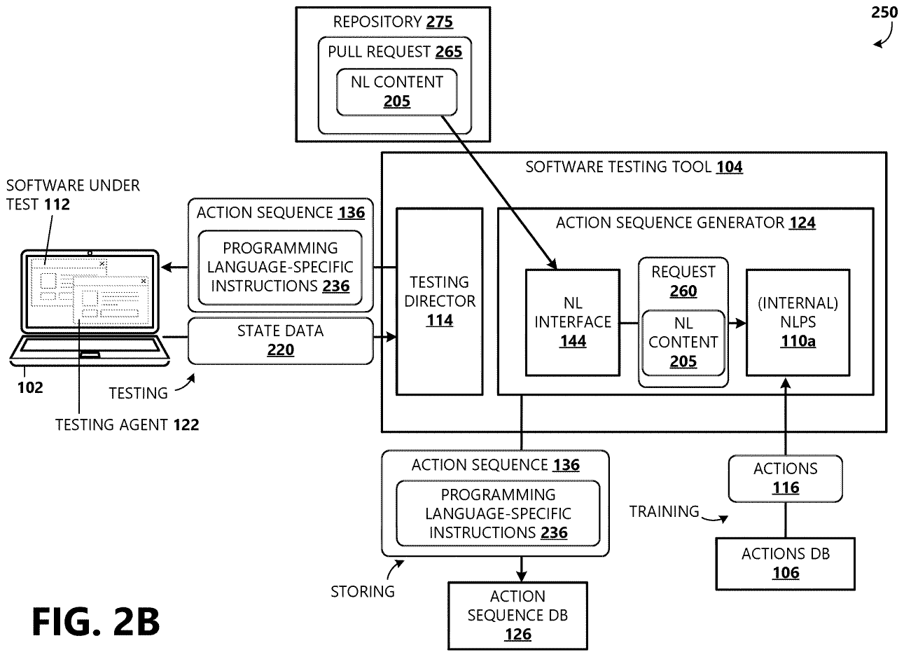

With reference now to FIG. 2A, a data flow 200 is depicted for providing automated action sequence generation according to an example implementation. In the depicted example, the messaging interface 134 receives natural language content 205 from a user of a computing device 202 in communication with the software testing tool 104. The software testing tool 104 is used to test software under test 112 operating on the test machine 102. In other implementations, the user may access the messaging interface 134 from a computing device that stores (or provides access to) the software under test 112. The user may provide natural language content 205 to the software testing tool 104 by typing, speaking, or otherwise inputting words or phrases into a user interface 234 surfaced on the computing device 202. In an example, the natural language content 205 is included in a message (e.g., a chat message) that is received by the messaging interface 134 of the software testing tool 104. The natural language content 205 may include lexical cues, syntactic cues, semantic cues, and/or pragmatic cues, indicative of instructions to perform actions 116 in association with the software under test 112. For instance, lexical cues are specific words or phrases that indicate actions often found in action instructions, such as verbs (e.g., “press,” “select,” “move,” or “retrieve”), nouns (e.g., “button,” “icon,” “tab,” or “mouse”), and/or adjectives and adverbs (e.g., “selected,” “up,” “down,” “right,” or “left”). Syntactic cues involve sentence structure and grammar used in action instructions, such as imperative sentences (e.g., “select the Home tab” or “upload the file”), sequential order (e.g., “first,” “next,” or “last”), and lists (e.g., bulleted or numbered text). Semantic cues are related to the meaning of words and phrases and provide context and clarify intended actions 116, such as references to specific UI elements, specified values for parameters or input fields (e.g., “name field,” “font size,” or “14 pt”), or specific interactions with data (e.g., “create a new contact with the following information” or “paste the copied text”). Pragmatic cues consider context and implied meaning within the natural language content 205, such as task flow indicators (e.g., “First, log into the user account. Then, navigate to the Settings page”).

In some examples, in response to receiving the natural language content 205, the messaging interface 134 provides the natural language content 205 to the action sequence generator 124 to generate an action sequence 136 for the software testing tool 104. For instance, the action sequence 136 may be generated based on portions of the natural language content 205 identified as commands or instructions of actions 116 to perform in relation to the software under test 112 (referred to as natural language action instructions 210 in FIG. 2A). According to an example, the action sequence generator 124 utilizes an NLPS 110 to identify cues in the natural language content 205 that indicate action instructions 210.

In the example data flow 200 depicted in FIG. 2A, the action sequence generator 124 utilizes an external NLPS 110b. The action sequence generator 124 generates a prompt 215 that includes the natural language content 205 and a request for the external NLPS 110b to identify natural language action instructions 210 included in the natural language content 205. The prompt 215 may be formed as a data package, payload, or object, such as in a JSON format. In some examples, the prompt 215 includes one or more expected segments that are expected (or required) to be included in each prompt 215 that is generated. In an example, the expected segments include a request segment 225 and a criteria segment 255. In a further example the request segment 225 includes a phrase that indicates the requested data. An example phrase for requesting natural language action instructions 210 is, “Identify instructions of actions that can be performed on a software product in the following natural language content based on the examples of actions that follow.” In another example, the criteria segment 255 provides instructions for the format of the output of the external NLPS 110b.

The prompt may also include one or more optional segments that are permitted (but are not required) to be included in each prompt 215 that is generated. For example, the optional segments may include natural language content 205 and the examples 245. The examples 245 may provide example input/output pairs to instruct the external NLPS 110b on the expected or desired outputs for particular inputs. In some examples, the examples 245 include natural language metadata included in action telemetry stored as actions 116 in the actions database 106. In some examples, the examples 245 include programming language-specific instructions of actions 116 included in action telemetry stored in the actions database 106.

The generated prompt 215 is then provided as input to the external NLPS 110b. The external NLPS 110b processes the prompt 215 and generates an output. The output generated from the external NLPS 110b in response to the prompt 215 is then received by the action sequence generator 124 (e.g., as a data package or payload, such as a JSON payload). In some examples, the output includes natural language action instructions 210 identified in the natural language content 205 that describe actions 116 that can be performed in association with the software under test 112. In other examples, the output includes programming language-specific instructions 236 corresponding to the identified natural language action instructions 210.

In some examples, such as when output from the external NLPS 110b includes natural language action instructions 210, the action sequence generator 124 may additionally use an internal NLPS 110a (not pictured) to convert the identified natural language action instructions 210 into programming language-specific language instructions 236. For instance, the internal NLPS 110a may be trained to convert natural language action instructions 210 into an action sequence 136 in the software testing tool's programming language-specific language based on training data including programming language-specific instructions 236 stored with actions 116 in the actions database 106. In examples, the generated action sequence 136 includes key value pairs with sufficient information for the software testing tool 104 to be able to perform actions 116 to perform a task.

As an illustrative example of the data flow 200, the user may input the following natural language content 205 (e.g., a message) into the user interface 234, “I need you to launch Application A, create a new document, and then type the text ‘Hello World’ in bold.” The natural language content 205 is received by messaging interface 134 and is provided to the action sequence generator 124 to process and generate an action sequence 136. The action sequence generator 124 generates a prompt 215 as input for the external NLPS 110b that triggers the external NLPS 110b to identify natural language action instructions 210 included in the natural language content 205. In an example implementation, the prompt 215 further triggers the external NLPS 110b to convert the natural language action instructions 210 into programming language-specific action instructions 236 for an action sequence 136. As an example, based on information included in the request segment 225, criteria segment 255, the natural language content 205, and the examples 245 provided in the prompt 215, a first example response 230 from the external NLPS 110b includes the following identified natural language action instructions 210: launch Application A, create a new document, select a Bold command, and type the text “Hello World.” A second example response 230 from the external NLPS 110b includes the following programming language-specific instructions 236 (e.g., JSON instructions):
{Action: Click, UIObject: StartMenuButton, Process: filemanager.exe}
{Action: Click, UIObject: AppAShortcut, Process: filemanager.exe}
{Action: Click, UIObject: NewDocumentButton, Process: AppA.exe}
{Action: Click, UIObject: BoldTextButton, Process: AppA.exe}
{Action: SendText, UIObject: Document, Process: AppA.exe, TextToSend: ‘Hello World’}.

The action sequence generator 124 generates an action sequence 136 including the programming language-specific instructions 236. In some examples, the action sequence generator 124 uploads the generated action sequence 136 to the action sequence database 126. In further examples, the messaging interface 134 provides the generated action sequence 136 to the user via the user interface 234. For instance, the user may want to review the action sequence 136 and/or run a test locally (e.g., manually) using the programming language-specific instructions 236 in the generated action sequence 136.

In yet further examples, the software testing tool 104 performs the action sequence 136 against the software under test 112. For instance, in a testing mode, the testing director 114 of the software testing tool 104 may provide the testing agent 122 operating on the test machine 102 with instructions to perform the action sequence 136. The testing agent 122 may observe a first state of the software under test 112, perform programming language-specific instructions 236 corresponding to actions 116 in the action sequence 136, and receive state data 220 indicating a next state of the software under test 112 as a result of performing the action sequence 136. In some examples, the state data 220 indicates a result 235 of testing the action sequence 136, which may be presented to the user via the messaging user interface 134.

With reference now to FIG. 2B, a data flow 250 is depicted for providing automated action sequence generation according to an example implementation. In the depicted example, the natural language interface 144 of the software testing tool 104 receives natural language content 205 from a pull request 265. For instance, for each pull request 265 uploaded to source code repository 275, the natural language interface 144 may automatically obtain text from the pull request 265 and code comments from files in the pull request 265. In the example depicted in FIG. 2B, the text and code comments (e.g., natural language content 205) are provided to an internal NLPS 110a in a request 260. The request 260 includes a request for the internal NLPS 110a to find text that describes steps for interacting with the software under test 112 and convert those steps into the software testing tool's programming language-specific language. For instance, the natural language content 205 may include the software author's natural language description of how changes to the software were tested. As described above, the internal NLPS 110a is trained to identify and convert natural language action instructions 210 into an action sequence 136 in the software testing tool's programming language-specific language based on training data. The training data may include natural language metadata and programming language-specific instructions 236 that are stored with actions 116 in the actions database 106. The output generated by the internal NLPS 110a includes programming language-specific instructions 236 corresponding to identified natural language instructions that describe actions 116 that can be performed (e.g., that a user may be instructed to do) in association with the software under test 112. The action sequence generator 124 further generates an action sequence 136 including the programming language-specific instructions 236 and stores the action sequence 136 in the action sequence database 126.

In some examples, the software testing tool 104 performs the action sequence 136 against the software under test 112. For instance, in a testing mode, the testing director 114 of the software testing tool 104 may provide the testing agent 122 operating on the test machine 102 with instructions to perform the action sequence 136. The testing agent 122 may observe a first state of the software under test 112, perform programming language-specific instructions 236 corresponding to actions 116 in the action sequence 136, and receive state data 220 indicating a next state of the software under test 112 as a result of performing the action sequence 136. In some examples, the state data 220 indicates a result 235 of testing the action sequence 136. Additionally, action telemetry data describing the actions 116 in the action sequence 136 performed on the software under test 112 during testing is collected and stored. In examples, the action telemetry data includes the programming language-specific instructions performed by the testing agent 122 and natural language metadata corresponding to taking the actions 116. In some examples, the action telemetry data is used to further train the NLPS 110.

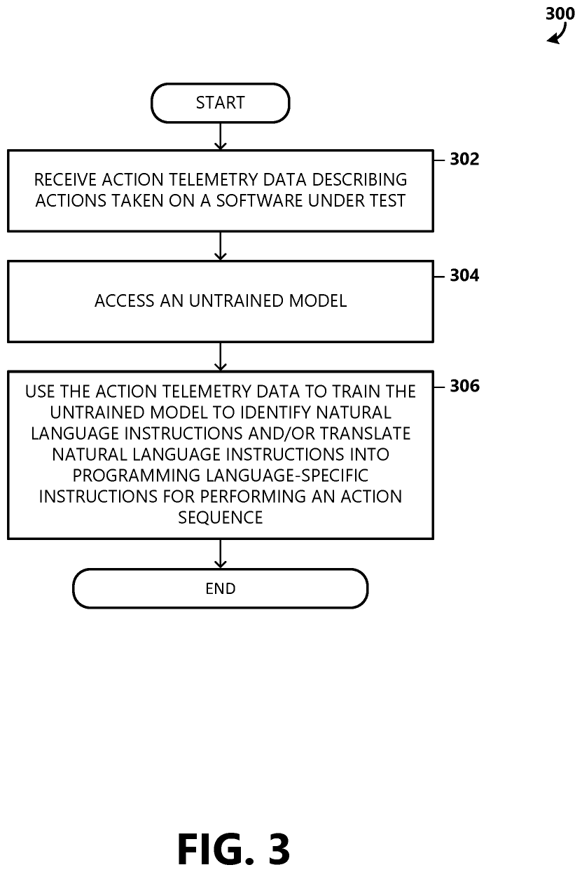

With reference now to FIG. 3, a flow chart illustrating an example method 300 for training a model to perform automated action sequence generation is provided. At operation 302, the example method 300 includes receiving action telemetry data describing actions 116 taken on at least one version of a software under test 112. For instance, the action telemetry data is received from the testing agent(s) 122 running on one or more test machines 102. The action telemetry data includes descriptions of actions 116 the testing agents 122 took on the test machines 102. In examples, the descriptions include programming language-specific instructions and natural language metadata corresponding to taking the actions 116. Actions 116 include interactions with the software under test. For example, actions 116 may include an action (e.g., select, hover, enter text) a user may perform for a UI element (e.g., button, menu or menu item, text box, checkbox, dropdown list, hyperlink, or other type of link) on a UI of the software under test. In one aspect, the actions 116 are determined through interrogation of an accessibility layer of the test machines 102.

At operation 304, the example method 300 includes accessing an untrained model. The untrained model can have weights and biases that are not set or are preset (e.g., set randomly set to default values, or set based on prior knowledge), which serve as the starting point for training and can be adjusted during training. For instance, the untrained model may be a neural network or statistical model that has not yet been exposed to any specific data or examples relevant to a particular task and the weights and biases have not been adjusted based on any real-world information or learning. It should be appreciated that the untrained model can be selected from many different model forms.

At operation 306, the example method 300 includes training the untrained model to identify natural language action instructions 210 using actions telemetry data received from testing agents 122. The training can be supervised learning, semi-supervised learning, unsupervised learning, reinforcement learning, and/or the like, including combinations and/or multiples thereof. According to one example training implementation, a loss function is defined for identifying natural language action instructions 210. Common loss functions include categorical cross-entropy for classification tasks and mean squared error for regression tasks. Additionally, the dataset is split into training, validation, and test sets. For instance, the training set is used for model training, the validation set helps tune hyperparameters and monitor training progress, and the test set is reserved for final evaluation. The model is trained on the training data using an optimization algorithm (e.g., stochastic gradient descent, Adaptive Moment Estimation (Adam), Root Mean Square Propagation (RMSprop)). During training, the model's weights and biases are adjusted iteratively to minimize the defined loss function. Additionally, over multiple iterations, hyperparameters, such as learning rate, batch size, and model architecture are fine-tuned based on the model's performance on the validation set. This step can involve multiple iterations. Further, regularization techniques (e.g., dropout, weight decay, or early stopping to prevent overfitting) are applied to help the model generalize better to unseen data. Training progress may be monitored by tracking metrics (e.g., loss, accuracy) on the validation set. In some examples, training curves are visualized to assess convergence or potential issues. The model's performance is assessed on the test set to determine its ability to generalize to new, unseen data. Based on the evaluation results, the model may be determined to have achieved a predefined or desired performance threshold or may be further fine-tuned (e.g., hyperparameters may be adjusted and/or additional data may be collected for retraining). The training may be performed multiple times (referred to as “epochs”) until a model reaches a predefined or desired performance threshold. Once trained, the trained model is configured to operate as the NLPS 110 to identify natural language action instructions 210 for performing actions 116 in an action sequence 136 by applying the trained model to received natural language content 205 from a natural language source 130. In some examples, the trained model is configured to operate as the NLPS 110 to further convert identified natural language action instructions 210 into programming language-specific instructions 236 for the software testing tool 104 to perform the actions 116.

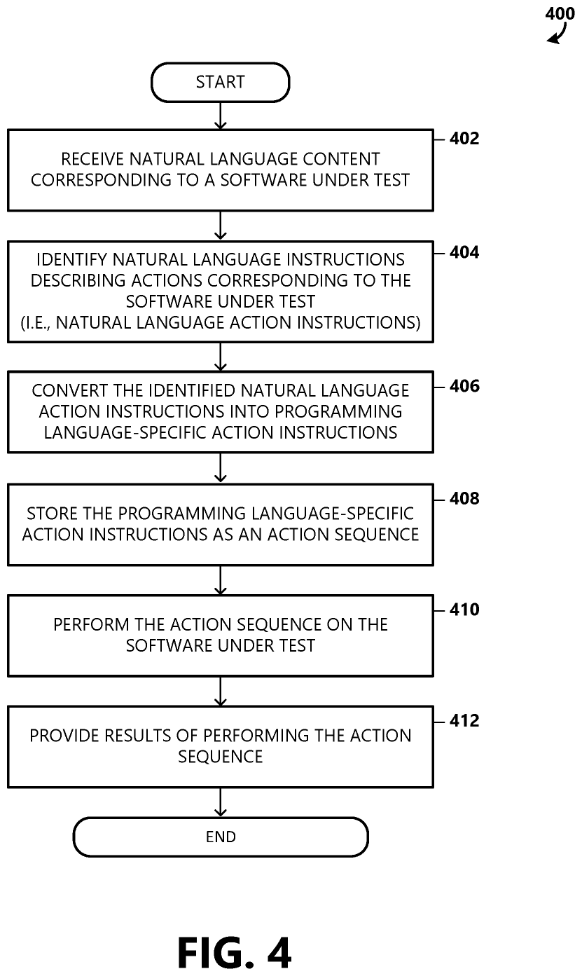

With reference now to FIG. 4, a flow chart illustrating an example method 400 for providing automated action sequence generation is provided. At operation 402, the example method 400 includes receiving natural language content 205. For instance, the natural language content 205 is received from a natural language source 130. Portions of the natural language content 205 can be identified as instructions to perform a sequence of actions 116 on a software product, where the software product is to be tested (e.g., a software under test 112) by the software testing tool 104. In some examples, the natural language content 205 is received via a messaging interface 134 that receives natural language messages from a user. In other examples, the natural language content 205 is received via a natural language interface 144 that obtains natural language content 205 from a pull request 265, a PM specification, a design document, a manual test, and/or another natural language source 130.

At operation 404, the example method 400 includes identifying natural language action instructions 210 included in the natural language content 205. In some examples, an NLPS 110 integrated with the action sequence generator 124, such as the internal NLPS 110a trained in example method 300, is used to identify cues included in the natural language content 205 that can be interpreted as natural language action instructions 210 and to convert (operation 406) the natural language action instructions 210 into programming language-specific instructions 236 for the software testing tool 104. For instance, the action sequence generator 124 may generate a prompt for the internal NLPS 110a that includes the natural language content 205 received in operation 402 and a request to identify different actions 116 from the natural language content 205 that a user may be instructed to perform and to convert the identified actions 116 into an action sequence 136 in the software testing tool's programming language-specific language. A response from the internal NLPS 110a may include the programming language-specific instructions 236.

In other examples, the action sequence generator 124 is in communication with an external NLPS 110b, where, at operation 404, the action sequence generator 124 generates a prompt 215 that includes the natural language content 205 received in operation 402. In some examples, the prompt 215 includes examples 245 of natural language metadata and a request segment 225 including a phrase that indicates a request to identify different actions 116 from the natural language content 205 that a user may be instructed to perform. In some examples, a response 230 from the external NLPS 110b includes natural language action instructions 210 identified in the natural language content 205. In other examples, the prompt 215 further includes examples 245 of programming language-specific language and a request segment 225 including a phrase that indicates a request to convert identified natural language action instructions 210 into the software testing tool's programming language-specific language. In some examples, the response 230 from the external NLPS 110b includes the programming language-specific instructions 236. In other examples, a second NLPS 110 (e.g., an internal NLPS 110a) is additionally used to convert the identified natural language action instructions 210 into programming language-specific language instructions 236. For instance, the internal NLPS 110a may be trained to convert natural language action instructions 210 into instructions in the software testing tool's programming language-specific language based on action telemetry training data.

At operation 408 of example method 400, the programming language-specific instructions 236 are stored as an action sequence 136 in the action sequence database 126. In examples, the instructions in the generated action sequence 136 includes key value pairs that enable the software testing tool 104 to perform the actions 116 to perform a task.

At operation 410, the action sequence 136 is exercised against the software under test 112. In examples, state data 220 is received in response to performing the action sequence 136. In some examples, at operation 412, results of performing the action sequence 136 are determined based on the state data 220. In some examples, the state data 220 indicates a result 235 of testing the actions sequence 136, which may be presented to the user via the messaging interface 134 and/or stored in a data store that stores the results 235. In examples, a plurality of actions sequences 136 are generated based on received or obtained natural language content 205 and are exercised against the software under test 112. For instance, action telemetry data describing the actions 116 in the action sequence 136 performed on the software under test 112 is collected and stored. In some examples, the programming language-specific instructions performed by the testing agent 122 and natural language metadata corresponding to taking the actions 116 included in the action telemetry data are used to further train the internal NLPS 110b.

FIG. 5 and the associated description provide a discussion of a variety of operating environments in which examples of the invention may be practiced. However, the devices and systems illustrated and discussed with respect to FIG. 5 is for purposes of example and illustration and is not limiting of a vast number of computing device configurations that may be utilized for practicing aspects of the invention, described herein. FIG. 5 is a block diagram illustrating physical components (i.e., hardware) of a computing device 500 with which examples of the present disclosure may be practiced. In a basic configuration, the computing device 500 may include at least one processing unit 502 and a system memory 504. The processing unit(s) (e.g., processors) may be referred to as a processing system. Depending on the configuration and type of computing device, the system memory 504 may comprise volatile storage (e.g., random access memory), non-volatile storage (e.g., read-only memory), flash memory, or any combination of such memories. The system memory 504 may include an operating system 505 and one or more program modules 506 suitable for running software applications 550 (e.g., the action sequence generator 124 and software testing tool 104).

The operating system 505, for example, may be suitable for controlling the operation of the computing device 500. Furthermore, aspects of the invention may be practiced in conjunction with a graphics library, other operating systems, or any other application program and is not limited to any particular application or system. This basic configuration is illustrated in FIG. 5 by those components within a dashed line 508. The computing device 500 may have additional features or functionality. For example, the computing device 500 may also include additional data storage devices (removable and/or non-removable) such as, for example, magnetic disks, optical disks, or tape. Such additional storage is illustrated in FIG. 5 by a removable storage device 509 and a non-removable storage device 510.

As stated above, a number of program modules and data files may be stored in the system memory 504. While executing on the processing unit 502, the program modules 506 may perform processes including one or more of the operations of the methods illustrated in FIGS. 3 and 4. Other program modules that may be used in accordance with examples of the present invention and may include applications such as electronic mail and contacts applications, word processing applications, spreadsheet applications, database applications, slide presentation applications, drawing or computer-aided application programs, etc.

Furthermore, examples of the invention may be practiced in an electrical circuit comprising discrete electronic elements, packaged or integrated electronic chips containing logic gates, a circuit utilizing a microprocessor, or on a single chip containing electronic elements or microprocessors. For example, examples of the invention may be practiced via a system-on-a-chip (SOC) where each or many of the components illustrated in FIG. 5 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to generating suggested queries, may be operated via application-specific logic integrated with other components of the computing device 500 on the single integrated circuit (chip). Examples of the present disclosure may also be practiced using other technologies capable of performing logical operations such as, for example, AND, OR, and NOT, including mechanical, optical, fluidic, and quantum technologies.

The computing device 500 may also have one or more input device(s) 512 such as a keyboard, a mouse, a pen, a sound input device, a touch input device, etc. The output device(s) 514 such as a display, speakers, a printer, etc. may also be included. The aforementioned devices are examples and others may be used. The computing device 500 may include one or more communication connections 516 allowing communications with other computing devices 518. Examples of suitable communication connections 516 include RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 504, the removable storage device 509, and the non-removable storage device 510 are all computer storage media examples (i.e., memory storage.) Computer storage media may include RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 500. Any such computer storage media may be part of the computing device 500. Computer storage media does not include a carrier wave or other propagated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, communication media may include wired media such as a wired network or direct-wired connection, and wireless media such as acoustic, radio frequency (RF), infrared, and other wireless media.

According to an aspect, a method is provided, comprising: receiving natural language content describing interactions with software under test; identifying, using a natural language processing system (NLPS), natural language instructions in the natural language content based on the interactions; converting the natural language instructions into programming language-specific instructions that, when executed by a software testing tool, perform testing of the software under test, where the programming language-specific instructions are formatted in a programming language-specific language of the software testing tool; and storing the programming language-specific instructions as a sequence of actions for testing the software under test.

According to another aspect, a computing system is provided, comprising: a processing system; and memory storing instructions that, when executed, cause the computing system to perform operations comprising: receiving natural language content from a natural language source describing testing a software under test; identifying, in the natural language content, natural language instructions that describe actions that can be performed against the software under test; converting the identified natural language instructions into programming language-specific instructions that a software testing tool can perform against the software under test in a sequence; and storing the programming language-specific instructions as an action sequence.

According to another aspect, a software testing tool is provided, comprising: a processing system; and memory storing instructions that, when executed, cause the software testing tool to: receive natural language content describing interactions with a software under test; identify, using natural language processing, natural language instructions in the natural language content based on the described interactions; and convert the natural language instructions into programming language-specific instructions that, when executed in an action sequence, perform testing of the software under test.

Aspects of the present invention, for example, are described above with reference to block diagrams and/or operational illustrations of methods, systems, and computer program products according to aspects of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved. Further, as used herein and in the claims, the phrase “at least one of element A, element B, or element C” is intended to convey any of: element A, element B, element C, elements A and B, elements A and C, elements B and C, and elements A, B, and C.

The description and illustration of one or more examples provided in this application are not intended to limit or restrict the scope of the invention as claimed in any way. The aspects, examples, and details provided in this application are considered sufficient to convey possession and enable others to make and use the best mode of claimed invention. The claimed invention should not be construed as being limited to any aspect, example, or detail provided in this application. Regardless of whether shown and described in combination or separately, the various features (both structural and methodological) are intended to be selectively included or omitted to produce an example with a particular set of features. Having been provided with the description and illustration of the present application, one skilled in the art may envision variations, modifications, and alternate examples falling within the spirit of the broader aspects of the general inventive concept embodied in this application that do not depart from the broader scope of the claimed invention.

We claim:

1. A method, comprising:
receiving natural language content describing interactions with software under test;
identifying, using a natural language processing system (NLPS), natural language instructions in the natural language content based on the interactions;
converting the natural language instructions into programming language-specific instructions that, when executed by a software testing tool, perform testing of the software under test, where the programming language-specific instructions are formatted in a programming language-specific language of the software testing tool; and
storing the programming language-specific instructions as a sequence of actions for testing the software under test.

2. The method of claim 1, wherein identifying the natural language instructions comprises:
generating a prompt for the NLPS, wherein the prompt includes the natural language content and a request for the NLPS to identify actions that can be performed against the software under test; and
providing the prompt as input to the NLPS.

3. The method of claim 2, further comprising, including, in the prompt, at least one of:
examples of the actions that can be performed against the software under test; or
natural language metadata that describe the actions that can be performed against the software under test.

4. The method of claim 2, wherein the prompt further includes a request to convert the identified natural language instructions into the programming language-specific instructions.

5. The method of claim 2, wherein the prompt further includes examples of the programming language-specific instructions that correspond to the natural language instructions.

6. The method of claim 2, wherein:
generating the prompt comprises generating a first prompt; and
converting the identified natural language instructions into the programming language-specific instructions comprises:
providing the first prompt as a first input into a first NLPS, where the first NLPS is an external NLPS;
in response to the first input, receiving a first output from the first NLPS, wherein the first output includes identified natural language instructions;
generating a second prompt;
including, in the second prompt, the identified natural language instructions and a request to convert the identified natural language instructions into the programming language-specific instructions;
providing the second prompt as a second input for a second NLPS; and
in response to the second input, receiving a second output from the second NLPS, wherein the second output includes the programming language-specific instructions.

7. The method of claim 1, wherein the NLPS is trained on training data including recorded actions performed against the software under test, the training data comprising:
respective programming language-specific instructions for each recorded action; and
natural language metadata describing the recorded action.

8. The method of claim 1, wherein receiving the natural language content comprises at least one of:
receiving a code update submission corresponding to a change made to source code of the software under test;
receiving a comment included in the source code;
receiving manually-authored instructions for testing the software under test;
a design document for the software under test; or
receiving a project management specification for the software under test.

9. The method of claim 1, wherein receiving the natural language content comprises receiving a message via a messaging interface.

10. The method of claim 1, further comprising:
performing the sequence of actions against the software under test; and
receiving action telemetry data recorded about each action in the sequence of actions performed against the software under test, the action telemetry data including:
respective programming language-specific instructions for each recorded action; and
natural language metadata describing each recorded action.

11. The method of claim 10, further comprising using the action telemetry data as training data for the NLPS.

12. A computing system, comprising: a processing system; and
memory storing instructions that, when executed, cause the computing system to perform operations comprising:
receiving natural language content from a natural language source describing testing a software under test;
identifying, in the natural language content, natural language instructions that describe actions that can be performed against the software under test;
converting the identified natural language instructions into programming language-specific instructions that a software testing tool can perform against the software under test in a sequence; and
storing the programming language-specific instructions as an action sequence.

13. The computing system of claim 12, wherein the natural language source includes at least one of: a message;
a code update submission corresponding to a change made to source code of the software under test;
a comment included in the source code;
manually-authored instructions for testing the software under test;
a project management specification for the software under test; or
a design document.

14. The computing system of claim 12, wherein identifying the natural language instructions that describe actions that can be performed against the software under test comprises generating an input for a natural language processing system (NLPS), wherein the input includes the natural language content and a request for the NLPS to identify the natural language instructions describing the actions that can be performed against the software under test.

15. The computing system of claim 14, wherein the input further comprises:
examples of the actions that can be performed against the software under test; and
natural language metadata that describe the actions.

16. The computing system of claim 15, wherein the input further comprises:
a request to convert the identified natural language instructions into the programming language-specific instructions; and
example programming language-specific instructions that correspond to the natural language metadata.

17. The computing system of claim 14, the operations further comprising:
providing the input to the NLPS;
in response to the input, receiving an output from the NLPS, wherein the output includes the identified natural language instructions; and
converting the identified natural language instructions into the programming language-specific instructions.

18. The computing system of claim 12, further comprising:
receiving, in response to executing the programming language-specific instructions against the software under test, action telemetry data recorded for each action in the action sequence, the action telemetry data including:
respective programming language-specific instructions for each recorded action; and
natural language metadata describing each recorded action; and
training the NLPS to identify the natural language instructions that describe the actions that can be performed against the software under test using training data including the action telemetry data.

19. A software testing tool, comprising:
a processing system; and
memory storing instructions that, when executed, cause the software testing tool to:
receive natural language content describing interactions with a software under test;
identify, using natural language processing, natural language instructions in the natural language content based on the described interactions; and
convert the natural language instructions into programming language-specific instructions that, when executed in an action sequence, perform testing of the software under test.

20. The software testing tool of claim 19, wherein identifying the natural language instructions and converting the natural language instructions into the programming language-specific instructions is based on training data including recorded actions performed against the software under test, the training data comprising: respective programming language-specific instructions for each recorded action; and
natural language metadata describing each recorded action.
